(19) United States
(12) Patent Application Publication
(10) Pub. No.: US 2008/0247540 A1
(43) Pub. Date: Oct. 9, 2008

(54) METHOD AND APPARATUS FOR PROTECTING DIGITAL CONTENTS STORED IN USB MASS STORAGE DEVICE

(75) Inventors: Chang-sup Ahn, Seoul (KR); Jun-bum Shin, Suwon-si (KR); Bong-seon Kim, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/872,161

(22) Filed: Oct. 15, 2007

(30) Foreign Application Priority Data
Apr. 5, 2007 (KR) 10-2007-0033780

(51) Int. Cl. H04L 9/28

(52) U.S. Cl. 380/44

(57) ABSTRACT

A method and apparatus for protecting digital content stored in a universal serial bus (USB) mass storage (UMS) device from unlimited distribution are provided. According to the method and apparatus, a UMS device generates a random key according to a request from a user and shows the generated random key to the user, and then, by using the random key, registration data is encrypted. Accordingly, only a USB host that registers the UMS device after the user connects the USB host directly to the UMS device, can freely use digital content of the UMS device, and even if encrypted registration data of the UMS is leaked out, unauthorized devices cannot register the UMS device.

### CROSS-REFERENCE TO RELATED PATENT APPLICATIONS

This application claims priority from Korean Patent Application No. 10-2007-0033780, filed on Apr. 5, 2007, in the Korean Intellectual Property Office, the disclosure of which is incorporated herein in its entirety by reference.

### BACKGROUND OF THE INVENTION

1. Field of the Invention

Apparatuses and methods consistent with the present invention relate to protection of digital content, and more particularly, to protecting digital content stored in a USB mass storage (UMS) device from unlimited distribution.

2. Description of the Related Art

Peripheral devices connected to a host system can use a serial port, a parallel port, or a universal serial bus (USB) port as a communication channel for exchanging data, and for this channel, an appropriate host system driver, a communication protocol, and an application program should be installed. However, installing each driver and related programs in order to connect a variety of apparatuses to the host system is very inefficient and inconvenient, and is a job which typical users are reluctant to do. In order to solve this inconvenience and in the case of a USB port, a USB mass storage (UMS) device class is defined, and is provided in many general-purpose operating systems such as Windows XP. Accordingly, a peripheral device complying with UMS specifications can be easily connected to a system and used even without installing a separate driver or application program.

As such, digital content can be unlimitedly and repeatedly copied, and therefore interests in and importance of security technologies for digital content have been gradually increasing. In order to protect digital content stored in a host system, a peripheral device having a usage right should have authentication information that can prove that the peripheral device is an authorized user or entity, and for this, the host and the peripheral device should safely share a secret key. However, if a UMS device is connected to a USB host, the UMS device operates as a simple storage device, and cannot actively perform a security function. As a representative example of when the UMS device is connected to the USB host, a USB movable hard disk cannot provide a function for encrypting or hiding a predetermined file and can only operate as a passive storage device. Also, in the case of a personal video recorder (PVR), the PVR can actively operate before the PVR is connected to a USB host, however, if the PVR is connected to the USB host, the firmware of the PVR stops operation of the PVR and the PVR is recognized only as a passive UMS device by the USB host. Accordingly, digital content stored in a UMS device is likely to be distributed unlimitedly by a USB host and used. Therefore, a method of preventing this is needed.

### SUMMARY OF THE INVENTION

Exemplary embodiments of the present invention overcome the above disadvantages and other disadvantages not described above. In addition, the present invention is not required to overcome the disadvantages described above, and an exemplary embodiment of the present invention may not overcome any of the problems described above.

An aspect of the present invention provides a method and apparatus for protecting digital content stored in a USB mass storage (UMS) device, in which only a USB host that a user connects the UMS device to through a USB port is made to register the UMS device in order to protect the digital content stored in the UMS device from unlimited distribution.

According to an aspect of the present invention, there is provided a method for a universal serial bus (USB) mass storage (UMS) device of managing its registration data, the method including: generating a random key according to a user input; displaying the generated key through a user interface; and encrypting the registration data by using the generated key, wherein the registration data includes information that a USB host connected to the UMS device must have in order to use encrypted digital content of the UMS device.

The encrypting of the registration data may be performed by using a predetermined symmetric key encryption algorithm.

In the encrypting of the registration data, the registration data and a share key which is shared with a predetermined USB host may be encrypted together by using the generated key.

According to another aspect of the present invention, there is provided a computer readable recording medium having embodied thereon a computer program for executing the method.

According to another aspect of the present invention, there is provided an apparatus for managing registration data of a UMS device, the apparatus including: a key generation unit which generates a random key according to a user input; a user interface which displays the generated key through a user interface; and an encryption unit which encrypts the registration data by using the generated key, wherein the registration data includes information that a USB host connected to the UMS device must have in order to use encrypted digital content of the UMS device.

According to another aspect of the present invention, there is provided a method for a USB host of registering a UMS device, the method including: requesting a key input through a user interface if encrypted data is readout from a predetermined storage location reserved for registration data of the UMS device; and by using a key which is input in response to the request, decrypting the encrypted data, wherein the registration data includes information that the USB host connected to the UMS device must have in order to use encrypted digital content of the UMS device.

Decrypting of the encrypted data may be performed by using a predetermined symmetric key encryption algorithm.

The method may further include extracting the registration data from the decrypted result by using a shared key that is shared with the UMS device.

According to another aspect of the present invention, there is provided a computer readable recording medium having embodied thereon a computer program for executing the method.

According to another aspect of the present invention, there is provided an apparatus including: a user interface which requests a key input through the user interface if encrypted data in a predetermined storage location for registration data of the UMS device is read; and a decryption unit which decrypts the encrypted data by using a key which is input in response to the request, wherein the registration data includes information that the USB host connected to the UMS device must have in order to use encrypted digital content of the UMS device.

### BRIEF DESCRIPTION OF THE DRAWINGS

The above and other features of the present invention will become more apparent by describing in detail exemplary embodiments thereof with reference to the attached drawings in which:

FIG. 1 is a diagram illustrating an environment to which an exemplary embodiment of the present invention applies;

FIG. 2 is a flowchart of a method of generating registration data by a USB mass storage (UMS) device, according to an exemplary embodiment of the present invention;

FIG. 3 is a flowchart of a method of performing double-encryption of registration data according to an exemplary embodiment of the present invention;

FIG. 4 is a diagram illustrating a structure of a UMS device according to an exemplary embodiment of the present invention;

FIG. 5 is a flowchart of a method of registering a UMS device to a USB host, according to an exemplary embodiment of the present invention; and

FIG. 6 is a diagram illustrating a structure of a USB host according to an exemplary embodiment of the present invention.

### DETAILED DESCRIPTION OF THE INVENTION

The present invention will now be described more fully with reference to the accompanying drawings, in which exemplary embodiments of the invention are shown.

FIG. 1 is a block diagram of an environment to which an exemplary embodiment of the present invention applies. As illustrated in FIG. 1, a USB mass storage (UMS) device 110 and a USB host 120 are connected to each other through a USB port. The UMS device 110 has encrypted and stored digital content, and keeps registration data at a predetermined location. The registration data is authentication information that is necessary for authorized use, or access of encrypted digital content of the UMS device. Before the USB host 120 is connected to the UMS device 110, that is, when the UMS device 110 can perform an active operation, the registration data is generated by a request from a user in advance, and is stored in a predetermined location.

For example, if the UMS device 110 encrypts digital content of the UMS device by using a content key, then stores the encrypted digital content and encrypts the content key with a device key of the UMS device 110, and if the USB host 120 has the device key of the UMS device 110, the USB host 120 can obtain the content key, and thereby, freely using all digital content of the UMS device 110. Accordingly, in this case the device key of the UMS device 110 can be registration data.

Since a device having registration data, i.e., a device that has registered the UMS device 110, can freely use the digital content of the UMS device 110, the registration data may be encrypted and stored. If decrypting of encrypted registration data is successful, the USB host 120 keeps the registration data in a safe location. However, if the encrypted registration data is leaked out through a USB channel in the process by the USB host 120 of fetching the encrypted registration data from the UMS device 110, and an unauthorized person cracks the encrypted registration data and obtains the registration data, it is difficult to prevent unlimited distribution of the digital content of the UMS device 110.

Accordingly, in the present invention, registration data is effectively encrypted and even if the encrypted registration data is leaked out, unlimited registration by unauthorized devices of the UMS device 110 can be prevented.

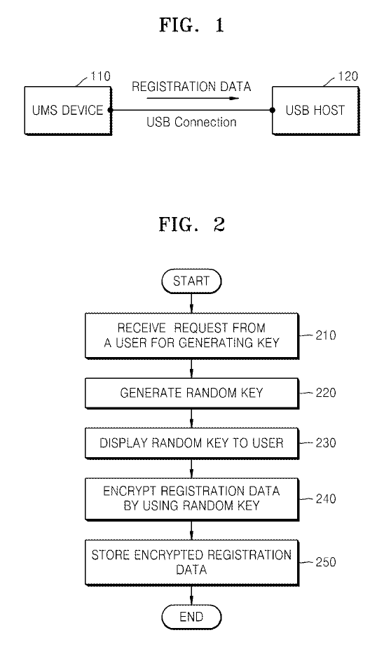

FIG. 2 is a flowchart of a method of generating registration data by a UMS device, according to an exemplary embodiment of the present invention.

In operation 210, a user requests generation of a key through a user interface of the UMS device.

This key generation request is for a USB host that is to register the UMS device, and in order to request the generation of a key, for example, the user selects a menu item such as “device registration” through the user interface of the UMS device.

In operation 220, the UMS device generates a random key by using a predetermined random function. In order to generate this random key, the user may input arbitrary numbers or letters.

In operation 230, the UMS device displays the random key generated through the user interface. In general, the random key is displayed through a display apparatus.

In operation 240, the UMS device encrypts its registration data by using the generated random key. In this case, a symmetric key encryption algorithm such as AES, DES and RC4, can be used, however, the algorithm is not limited to these.

In operation 250, the encrypted registration data is stored in a predetermined location. As described above, this location is a predetermined location so that a USB host that is to be connected to the UMS device can learn. After the USB host, which wants to register the UMS device, is connected to the UMS device, the USB host accesses this location and fetches the registration data. After fetching the registration data of the UMS device, the USB host may delete the registration data stored in the UMS device in order to prevent reuse of the registration data.

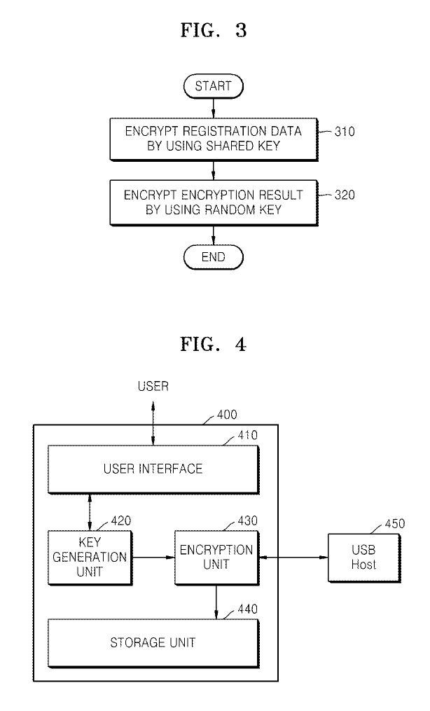

FIG. 3 is a flowchart of a method of performing double-encryption of registration data according to an exemplary embodiment of the present invention.

In operation 310, registration data is encrypted by using a shared key that is shared by a UMS device and a USB host in advance.

In operation 320, the encrypted result is again encrypted by using a random key.

In this way, if the registration data is first encrypted by using the shared key and then, encrypted again by using the random key, security can be strengthened more than if the registration data is encrypted only once by using a random key.

However, a shared key and registration data may be encrypted together by using a random key. If the shared key and registration data are encrypted together, even if an unauthorized device obtains the encrypted data, it is difficult to accurately extract the registration data from decrypted data. That is, only a device having the shared key can accurately extract the registration data from the decrypted data and register the UMS device.

FIG. 4 is a diagram illustrating a structure of a UMS device 400 according to an exemplary embodiment of the present invention.

As illustrated in FIG. 4, the UMS device 400 according to the current exemplary embodiment includes a user interface 410, a key generation unit 420, an encryption unit 430, and a storage unit 440.

The user interface 410 receives a request from a user to generate a random key, and if the random key is generated, the user interface 410 displays the generated random key to inform the user.

If the request from the user to generate of a random key is received, the key generation unit 420 generates the random key by using a predetermined random function.

The encryption unit 430 encrypts the registration data of the UMS device 400 by using the random key generated in the key generation unit 420. In this case, a symmetric key encryption algorithm may be used by the encryption unit 430. As described above, the encryption unit 430 may perform double encryption of the registration data by using a shared key, or may encrypt the registration data together with the shared key.

The storage unit 440 stores the registration data encrypted in the encryption unit 430 in a predetermined location. The USB host 450, which is connected to the UMS device 400, accesses the predetermined location of the storage unit 440 and fetches the encrypted registration data.

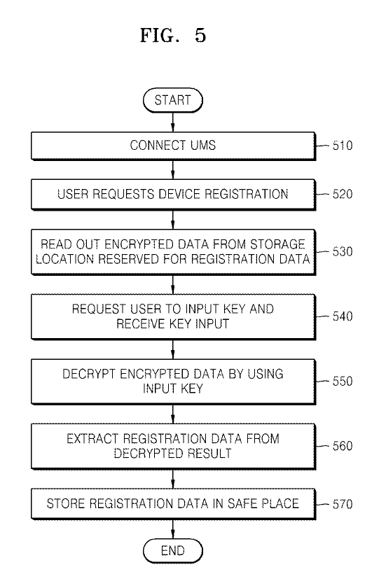

FIG. 5 is a flowchart of a method of registering a UMS device by a USB host, according to an exemplary embodiment of the present invention.

In operation 510, the USB host accesses the UMS device that is to be registered by the USB host.

In operation 520, through a user interface of the USB host, a user requests registration of the UMS device.

In operation 530, according to the request from the user, the USB host accesses a predetermined location of the UMS device and finds encrypted data.

In operation 540, the user is requested to input a key through the user interface of the USB host, and then, the key input by the user is received. In this case, the user should input a random key generated through the UMS device.

In operation 550, the UMS device decrypts the encrypted data by using the key input by the user.

In operation 560, by using a shared key, registration data is extracted from the data, which is obtained as the result of the decryption by using the key input by the user. This operation may include a process in which decoding is performed once more by using the shared key, or a process in which only registration data is obtained by removing a data part corresponding to the shared key.

Hence, operation 560 is an optional process that is only required if double encryption of the registration is performed by using the shared key, or the registration data is encrypted together with the shared key.

In operation 570, the extracted registration data is stored in a safe location of the USB host. Thus, the stored registration data will be referred to when the digital content of the UMS device is used in the future.

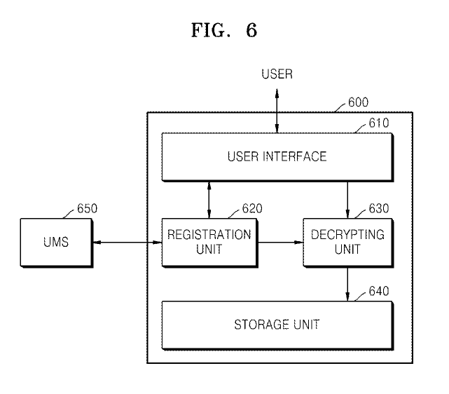

FIG. 6 is a diagram of a structure of a USB host 600 according to an exemplary embodiment of the present invention.

As illustrated in FIG. 6, the USB host 600 according to the current exemplary embodiment includes a user interface 610, a registration unit 620, a decryption unit 630, and a storage unit 640.

The user interface 610 receives a request for registration of a UMS device 650 from a user. Also, when the registration data of the UMS device 650 is encrypted, the user interface 610 requests the user to input a key, and receives a key input by the user according to the request.

If the user requests registration of the UMS device 650, the registration unit 620 reads and fetches encrypted registration data from a predetermined location of the UMS device 650. The decryption unit 630 decrypts the encrypted registration data by using the value input by the user. In this case, the same symmetric key encryption algorithm as is used in the encryption process of the registration data in the UMS device 650 is used. If double encryption of the registration data is performed by using a shared key or the registration data is encrypted together with the shared key, the decryption unit 630 decrypts the registration data by using a key input by the user and then, extracts the registration data from the decrypted data, by using the shared key.

The storage unit 640 stores the registration data extracted by the decryption unit 630 in a safe location. If the registration data is stored in the storage unit 640, the registration procedure of the UMS device is completed.

According to the present invention, only a USB host that registers the UMS device after the user connects the USB host directly to the UMS device can freely use digital content of the UMS device, and even if encrypted registration data of the UMS is leaked out, unauthorized devices cannot register the UMS device. Accordingly, unlimited distribution of the digital content stored in the UMS device can be ultimately prevented.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by one of ordinary skill in the art that various changes in form and details may be made therein without departing from the spirit and scope of the present invention as defined by the following claims. The exemplary embodiments should be considered in a descriptive sense only and not for purposes of limitation. Therefore, the scope of the invention is defined not by the detailed description of the invention but by the appended claims, and all differences within the scope should be construed as being included in the present invention.

What is claimed is:

1. A method for a universal serial bus (USB) mass storage (UMS) device of managing registration data of the UMS device, the method comprising:
receiving a request to generate a random key;
generating the random key;
displaying the generated random key; and
encrypting the registration data using the generated random key,
wherein the registration data comprises information a USB host connected to the UMS device uses to access encrypted digital content of the UMS device.

2. The method of claim 1, wherein the encrypting of the registration data is performed using a symmetric key encryption algorithm.

3. The method of claim 1, wherein in the encrypting of the registration data, the registration data and a share key, which is shared with the USB host, are encrypted together using the generated key.

4. A computer readable recording medium having embodied thereon a computer program for executing a method, the method comprising:
receiving a request to generate a random key;
generating the random key;
displaying the generated random key; and
encrypting the registration data using the generated random key,
wherein the registration data comprises information a universal serial bus (USB) host connected to a USB mass storage (UMS) device uses to access encrypted digital content of the UMS device.

5. An apparatus for managing registration data of a universal serial bus (USB) mass storage (UMS) device, the apparatus comprising:
a key generation unit which generates a random key according to an input;
a user interface which receives the input and displays the generated random key; and
an encryption unit which encrypts the registration data using the generated random key,
wherein the registration data comprises information a USB host connected to the UMS device uses to access encrypted digital content of the UMS device.

6. The apparatus of claim 5, wherein the encryption unit encrypts the registration data using a symmetric key encryption algorithm.

7. The apparatus of claim 5, wherein the encryption unit encrypts the registration data together with a share key that is shared with the USB host using the generated random key.

8. A method for a universal serial bus (USB) host of registering a USB mass storage (UMS) device, the method comprising:
requesting a key input if encrypted data is readout from a storage location reserved for registration data of the UMS device; and
decrypting the encrypted data using the key input in response to the request, wherein the registration data comprises information the USB host connected to the UMS device uses to access encrypted digital content of the UMS device.

9. The method of claim 8, wherein decrypting of the encrypted data is performed using a symmetric key encryption algorithm.

10. The method of claim 8, further comprising extracting the registration data from the decrypted result using a shared key that is shared with the UMS device.

11. A computer readable recording medium having embodied thereon a computer program for executing a method, the method comprising:
requesting a key input if encrypted data is readout from a storage location reserved for registration data of the UMS device; and
decrypting the encrypted data using the key input in response to the request, wherein the registration data comprises information the USB host connected to the UMS device uses to access encrypted digital content of the UMS device.

12. An apparatus comprising:
a user interface which requests a key input if encrypted data in a storage location for registration data of a universal serial bus (USB) mass storage (UMS) device is read; and
a decryption unit decrypting the encrypted data using the key input in response to the request,
wherein the registration data comprises information the USB host connected to the UMS device uses to access encrypted digital content of the UMS device.

13. The apparatus of claim 12, wherein the decryption unit decrypts the encrypted data using a symmetric key encryption algorithm.

14. The apparatus of claim 12, wherein the decryption unit decrypts the encrypted data using the input key, and extracts the registration data from the decrypted result using a shared key that is shared with the UMS device.
